(19) United States
(12) Patent Application Publication
(10) Pub. No.: US 2003/0236337 A1
(43) Pub. Date: Dec. 25, 2003

(54) Glass fiber reinforced polypropylene resin pellet and vehicle front structure obtained therefrom

(75) Inventors: Makoto Nagata, Ichinara (JP); Yoshiaki Oobayashi, Ichinara (JP); Isamu Inai, Higashiura (JP); Masakazu Atsumi, Handa (JP)

Correspondence Address: SUGHRUE MION, PLLC, 2100 Pennsylvania Avenue, N.W., Washington, DC, 20037-3213, US

(73) Assignees: SUMITOMO CHEMICAL COMPANY, LIMITED; DENSO CORPORATION

(21) Appl. No.: 10/421,799

(22) Filed: Apr. 24, 2003

(30) Foreign Application Priority Data
Apr. 26, 2002 (JP) 2002-126182

(51) Int. Cl. C08K 3/40

(52) U.S. Cl. 524/494; 524/236; 524/115

(57) ABSTRACT

Provided are a glass fiber reinforced polypropylene resin pellet which undergoes little of mechanical strength lowering under circumstances of contact with metal and a vehicle front structure obtained from the resin pellet.

A glass fiber reinforced polypropylene resin pellet comprising polypropylene resin (A), glass fiber (B), heavy metal deactivator (C), phenol-based antioxidant (D), sulfur-containing antioxidant (E), hindered amine-based light stabilizer (F), phosphorus-containing antioxidant (G) and ultraviolet absorber (H), wherein, as regards the weight of the respective components, the ratios (A)/(B), (C)/[(A)+(B)], (D)/[(A)+(B)], (E)/(D), (F)/(D), (G)/(D) and (H)/(D) are each in their respective specific ranges, the component (B) is arranged in parallel to one another with a length approximately equal to a pellet length, the pellet length is in a specific range, and an intrinsic viscosity of the component (A) is in a specific range, and a vehicle front structure obtained from the pellet.

### FIELD OF THE INVENTION

This invention relates to a glass fiber reinforced polypropylene resin pellet which undergoes little of mechanical strength lowering under circumstances of contact with metal, to a vehicle front structure obtained from the resin pellet, and to a production process thereof.

Polypropylene resin is in wide use as a general purpose resin because it is excellent in moldability and chemical resistance and has a low specific gravity. However, it is not always satisfactory in respect of mechanical strength and heat resistance and hence is rather restricted in its use. As a means for ameliorating such shortcomings and improving the mechanical strength of polypropylene resin such as rigidity and impact strength, it is already known to incorporate fillers, glass fiber, or the like into the resin. In industrial practice, also, there have been produced fiber reinforced polypropylene resins obtained by mixing short fibers, such as chopped strands, with polypropylene resin and granulating the mixture with a kneader, but such products have not yet been fully satisfactory.

### BACKGROUND OF THE INVENTION

Accordingly, some attempts have been made to increase the mechanical strength greatly by using fiber of large fiber length. JP-A-3-121146 discloses a process for producing glass fiber reinforced polypropylene resin pellet obtained by a method which comprises, as an application of pultrusion molding, impregnating continuous fiber strands with molten polypropylene resin while the fiber strands are being pulled, thereby to incorporate into the resin 5-80% by weight, relative to the total composition, of fiber arranged practically in parallel. The glass fiber reinforced polypropylene resins produced by using such pultrusion molding methods have been improved in mechanical properties, as rigidity and impact strength.

### SUMMARY OF THE INVENTION

Up to now, polypropylene resin has had a problem that when it is applied to uses in which it contacts directly with metal, it becomes susceptible to thermal oxidative degradation, resulting in lowered mechanical strength. A glass fiber reinforced polypropylene resin composition also has had the same problem and, when it is used as a material for a vehicle front structure which contacts with metal parts of automobiles, it cannot sufficiently keep mechanical strength in long-term use. Therefore, improvement in such properties of polypropylene resin has been eagerly awaited.

This invention relates to the improvement of durability under circumstances of contact with metals of glass fiber reinforced polypropylene resin pellet and vehicle front structures obtained therefrom.

After extensive study, the present inventors have found that the above-mentioned problem can be solved by adding specific amounts of a heavy metal deactivator, phenol-based antioxidant, sulfur-containing antioxidant, hindered amine-based light stabilizer, phosphorus-containing antioxidant and ultraviolet absorber, and resultantly have completed this invention.

Thus, this invention relates to a glass fiber reinforced polypropylene resin pellet comprising the following components (A)-(H), the ratio of the weight of the component (A) to the weight of the component (B) (component (A)/component (B)) being 20/80-95/5, the ratio of the weight of the component (C) to the total weight of the component (A) and the component (B) (component (C)/[component (A)+component (B)]) being 0.30/100-5/100, the ratio of the weight of the component (D) to the total weight of the component (A) and the component (B) (component (D)/[component (A)+component (B)]) being 0.15/100-5/100, the ratio of the weight of the component (E) to the weight of the component (D) (component (E)/component (D)) being 1/1-3/1, the ratio of the weight of the component (F) to the weight of the component (D) (component (F)/component (D)) being not less than 1/10 and not more than 1/2, the ratio of the weight of the component (G) to the weight of the component (D) (component (G)/component (D)) being not less than 1/10 and not more than 1/2 and the ratio of the weight of the component (H) to the weight of the component (D) (component (H)/component (D)) being not less than 1/10 and not more than 1/2, wherein the component (B) is arranged in parallel to one another with a length approximately equal to a pellet length, the pellet length is 2-50 nm, and an intrinsic viscosity of the component (A) in tetralin at 135° C. is not less than 1.15 dl/g and not more than 1.50 dl/g,

(A): polypropylene resin,

(B): glass fiber,

(C): heavy metal deactivator,

(D): phenol-based antioxidant,

(E): sulfur-containing antioxidant,

(F): hindered amine-based light stabilizer,

(G): phosphorus-containing antioxidant

(H): ultraviolet absorber.

This invention further relates to a vehicle front structure obtained by melt-kneading the above-mentioned pellet, feeding the resulting molten pellet to a mold comprising a pair of male and female dies, and then solidifying it, and to a process for producing the above-mentioned vehicle front structure.

### DETAILED DESCRIPTION OF THE INVENTION

The component (A) in this invention is polypropylene resin. The polypropylene resin used in this invention can be propylene homopolymer, ethylene-propylene random copolymer, and composite polymer obtained by first homopolymerizing propylene and then copolymerizing ethylene and propylene to form an ethylene-propylene copolymer part.

The process for producing the polypropylene resin is not particularly restricted and can be any of the processes of solution polymerization, slurry polymerization, bulk polymerization and gas phase polymerization exemplified in “New Polymer Production Process (edited by Yasuji SAEKI, KOGYO CHOSAKAI PUBLISHING CO. (1994)), JP-A-4-323207, JP-A-61-287917 and other literature. The resin can also be produced by combination of these processes. A catalyst used for the production can be various ones known to the art, preferred examples of which include a multi-site catalyst obtained by using a solid catalyst components containing titanium atom, magnesium atom and halogen atom, or a single-site catalyst obtained by using a metallocene complex, etc.

The component (B) in this invention is glass fiber. A binder used for forming the glass fiber into strands is not particularly limited and can be, for example, polypropylene resin, polyurethane resin, polyester resin, acrylic resin, epoxy-based resin, starch, vegetable oil, or the like. The binder can further be incorporated with acid-modified polypropylene resin, a surface treating agent, and a lubricant, such as paraffin wax.

In this invention, the above-mentioned fiber can be treated beforehand with a surface treating agent to improve its wettability and adhesive property with resins. The surface treating agent can be, for example, a coupling agent of silane type, titanate type, aluminum type, chromium type, zirconium type and borane type. Preferred of these are a silane type coupling agent and titanate type coupling agent, particularly preferred being a silane type coupling agent. Examples of the silane type coupling agent include triethoxysilane, vinyltris(β-methoxyethoxy)-silane, γ-methacryloxypropyltrimethoxysilane, γ-glycidoxypropyltrimethoxysilane, β-(3,4-epoxycyclohexyl)ethyltrimethoxysilane, N-β-(aminoethyl)-γ-aminopropyltrimethoxysilane, N-β-(aminoethyl)-γ-aminopropylmethyldimethoxysilane, γ-aminopropyltriethoxysilane, N-phenyl-γ-amino-propyltrimethoxysilane, γ-mercaptopropyltrimethoxysilane and γ-chloropropyltrimethoxyysilane. Particularly preferred of these are aminosilanes, e.g., γ-aminopropyltriethoxysilane and N-β-(aminoethyl)-γ-aminopropyltrimethoxysilane. The method used for treating the fiber with the above-mentioned surface treating agent is not particularly limited and can be any of the conventional methods, for example, an aqueous solution method, organic solvent method and spraying method.

The component (C), heavy metal deactivator, used in this invention can be the following compound comprising a salicyclic acid derivative.

Adekastab CDA-1, CDA-1M: 3-(N-salicyloyl)amino-1,2,4-triazole, mfd. by Asahi Denka Co., Ltd.

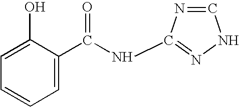

The component (D) in this invention is a phenol-based antioxidant. The phenol-based antioxidant used in this invention can be, for example, the following compounds:

tetrakis[methylene-3-(3′,5′-di-t-butyl-4-hydroxyphenyl)propionate]methane, octadecyl-3-(3,5-di-t-butyl-4-hydroxyphenyl)propionate, 3,9-bis[2-{3-(3-t-butyl-4-hydroxy-5-methylphenyl)propionyloxy}-1,1-dimethylethyl]-2,4,8,10-tetraoxaspiro[5.5]undecane, triethyleneglycol-N-bis-3-(3-t-butyl-5-methyl-4-hydroxyphenyl)propionate, 1,6-hexanediolbis[3-(3,5-di-t-butyl-4-hydroxyphenyl)propionate], and 2,2-thiobis-diethylenebis[3-(3,5-di-t-butyl-4-hydroxyphenyl)-propionate].

These phenol-based antioxidants can be used in a combination of two or more thereof as well as singly.

The component (E) in this invention is a sulfur-containing antioxidant. The sulfur-containing antioxidant used in this invention can be, for example, the following compounds:

dilauryl 3,3′-thiodipropionate, tridecyl 3,3′-thiodipropionate, dimyristyl 3,3′-thiodipropionate, distearyl 3,3′-thiodipropionate, lauryl stearyl 3,3′-thiodipropionate, neopentanetetrayltetrakis(3-laurylthiopropionate), and bis[2-methyl-4-(3-n-alkyl(C12-C14 thiopropionyloxy)-5-t-butylphenol]sulfide.

These sulfur-containing antioxidants can be used in a combination of two or more thereof as well as singly.

The component (F) in this invention is a hindered amine-based light stabilizer. The hindered amine-based light stabilizer used in this invention can be, for example, the following compounds:

bis(2,2,6,6-tetramethyl-4-piperidyl) sebacate, bis(2,2,6,6-(tetramethyl-4-piperidyl) succinate, bis(1,2,2,6,6-pentamethyl-4-piperidyl) sebacate, bis(N-octoxγ-2,2,6,6-tetramethyl-4-piperidyl) sebacate, bis(N-benzyloxγ-2,2,6,6-tetramethyl-4-piperidyl) sebacate, bis(N-cyclohexyloxy-2,2,6,6-tetramethyl-4-piperidyl) sebacate, bis(1,2,2,6,6-pentamethyl-4-piperidyl) 2-(3,5-di-t-butyl-4-hydroxybenzyl)-2-butylmalonate, bis(1-acroyl-2,2,6,6-tetramethyl-4-piperidyl) 2,2-bis(3,5-di-t-butyl-4-hydroxybenzyl)-2-butylmalonate, bis(1,2,2,6,6-pentamethyl-4-piperidyldecanedioate, 2,2,6,6-tetramethyl-4-piperidylmethacrylate, 4-[3-(3,5-di-t-butyl-4-hydroxyphenyl)propionyloxy]-1-[2-(3-(3,5-di-t-butyl-4-hydroxyphenyl)propionyloxy)ethyl]-2,2,6,6-tetramethylpiperidine, 2-methyl-2-(2,2,6,6-tetramethyl-4-piperidyl)amino-N-(2,2,6,6-tetramethyl-4-piperidyl)propionamide, tetrakis(2,2,6,6-tetramethyl-4-piperidyl)1,2,3,4-butanetetracarboxylate, tetrakis(1,2,2,6,6-pentamethyl-4-piperidyl)1,2,3,4-butanetetracarboxylate, mixed esters of 1,2,3,4-butanetetracarboxylic acid, 1,2,2,6,6-pentamethyl-4-piperidinol and 1-tridecanol, mixed esters of 1,2,3,4-butanetetracarboxylic acid, 2,2,6,6-tetramethyl-4-piperidinol and 1-tridecanol, mixed esters of 1,2,3,4-butanetetracarboxylic acid, 1,2,2,6,6-pentamethyl-4-piperidinol and 3,9-bis(2-hydroxy-1,1-dimethylethyl)-2,4,8,10-tetraoxaspiro[5.5]undecane, mixed esters of 1,2,3,4-butanetetracarboxylic acid, 2,2,6,6-tetramethyl-4-piperidinol and 3,9-bis(2-hydroxy-1,1-dimethylethyl)-2,4,8,10-tetraoxaspiro[5.5]undecane, polycondensation products of dimethyl succinate with 1-(2-hydroxyethyl)-4-hydroxy-2,2,6,6-tetramethylpiperidine, polycondensation products of poly[6-morpholino-1,3,5-triazine-2,4-diyl)-((2,2,6,6-tetramethyl-4-piperidyl)imino)hexamethylene((2,2,6,6-tetramethyl-4-piperidyl)imino)], poly[6-(1,1,3,3-tetramethylbutyl)imino-1,3,5-triazine-2,4-diyl((2,2,6,6-tetramethyl-4-piperidyl)imino)-hexamethylene((2,2,6,6-tetramethyl-4-piperidyl)imino)), polycondensation products of N,N′-bis(2,2,6,6-tetramethyl-4-piperidyl)hexamethyleneiamine with 1,2-dibromoethane, N,N′,4,7-tetrakis[4,6-bis(N-butyl-N-(2,2,6,6-tetramethyl-4-piperidyl)amino)-1,3,5-triazin-2-yl]-4,7-diazadecane-1,10-diamine, N,N′,4-tris[4,6-bis[N-butyl-N-(2,2,6,6-tetramethyl-4-piperidyl)amino)-1,3,5-triazin-2-yl]-4,7-diazadecane-1,10-diamine, N,N′,4,7-tetrakis[4,6-bis(N-butyl-N-1,2,2,6,6-pentamethyl-4-piperidyl)amino]-1,3,5-triazin-2-yl]-4,7-diazadecane-1,10-diamine, N,N′,4-tris[4,6-bis(N-butyl-N-(1,2,2,6,6-pentamethyl-4-piperidyl)amino)-1,3,5-triazin-2-yl]-4,7-diazadecane-1,10-diamine, and mixtures of at least two or more thereof.

The component (G) in this invention is a phosphorus-containing antioxidant. The phosphorus-containing antioxidant used in this invention can be, for example, the following compounds:

triphenyl phosphite, tris(nonylphenyl) phosphite, tris(2,4-di-t-butylphenyl)phosphite, trilauryl phosphite, trioctadecyl phosphite, distearylpentaerythritol diphosphite, diisodecylpentaerythritol diphosphite, bis(2,4-di-t-butylphenol)pentaerythritol diphosphite, bis(2,4-di-t-butyl-6-methylphenyl)pentaerythritol diphosphite, bis(2,6-di-t-butyl-4-methylphenyl)pentaerythritol diphosphite, bis(2,4,6-tri-t-butylphenyl)-pentaerythritol diphosphite, tristearylsorbitol triphosphite, tetrakis(2,4-di-t-butylphenyl)-4,4′-diphenylene diphosphonite, 2,2′-methylenebis(4,6-di-t-butylphenyl)-2-ethytlhexyl phosphite, 2,2′-ethylidenebis(4,6-di-t-butylphenyl)fluorophosphite, bis(2,4-di-t-butyl-6-methylphenyl)ethyl phosphite, bis(2,4-di-t-butyl-6-methylphenyl)methyl phosphite, 2-(2,4,6-tri-t-butylphenyl)-5-ethyl-5-butyl-1,3,2-oxaphosphorinane and 2,2′,2″-nitrilo[triethyl-tris(3,3′,5,5′-tetra-t-butyl-1,1′-biphenyl-2,2′-diyl)phosphite.

Particularly preferably used are bis(2,4-di-t-butylphenyl)pentaerythritol diphosphite and tris(2,4-di-t-butylphenyl)phosphite.

The component (H) in this invention is an ultraviolet absorber. The ultraviolet absorber used in this invention can be, for example, acrylate type ultraviolet absorbers, nickel-based ultraviolet absorbers, oxamide type ultraviolet absorbers, 2-(2-hydroxyphenyl)-1,3,5-triazine type ultraviolet absorbers and benzoate type ultraviolet absorbers.

Specific examples of the acrylate type ultraviolet absorbers include ethyl-α-cyano-β,β-diphenyl acrylate, isooctyl-α-cyano-β,β-diphenyl acrylate, methyl-α-carbomethoxycinnamate, methyl-α-cyano-β-methyl-p-methoxycinnamate, butyl-α-cyano-β-methyl-p-methoxycinnamate, methyl-α-carbomethoxy-p-methoxycinnamate and N-(β-carbomethoxy-β-cyanovinyl)-2-methylindoline, and mixtures of at least two thereof.

Specific examples of the nickel-based ultraviolet absorbers include, for example, nickel complexes of 2,2′-thiobis-[4-(1,1,3,3-tetramethylbutyl)phenol], nickel salts of nickeldibutyldithiocarbamate monoalkyl esters, nickel complexes of ketoxine, and mixtures of at least two thereof.

Specific examples of the oxamide type ultraviolet absorbers include 4,4′-dioctyloxyoxanilide, 2,2′-diethoxyoxanilide, 2,2′-dioctyloxy-5,5′-di-t-butylanilide, 2,2′-didodecyloxy-5,5′-di-t-butylanilide, 2-ethoxy-2′-ethyloxanilide, N,N′-bis(3-dimethylaminopropyl)oxamide, 2-ethoxy-5-t-butyl-2′-ethoxyanilide, 2-ethoxy-5,4′-di-t-butyl-2′-ethyloxanilide, and mixtures of at least two thereof.

Specific examples of the 2-(2-hydroxyphenyl)-1,3,5-triazine type ultraviolet absorbers include 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-[2,4-dihydroxyphenyl-4,6-bis(2,4-dimethylphenyl)]-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethylphenyl)-1,3,5-triazine, 2-[2-hydroxy-4-(2-hydroxy-3-octyloxypropoxy)phenyl]-4,6-bis(2,4-dimethylphenyl)-1,3,5-triazine, and mixtures of at least two thereof.3

Specific examples of the benzoate type ultraviolet absorber include 2,4-di-t-butylphenyl 3′,5′-di-t-butyl-4′-hydroxybenzoate.

The “modified polypropylene resin” in this invention includes a resin obtained by graft-polymerizing an unsaturated carboxylic acid and/or its derivative onto a propylene homopolymer or a copolymer of propylene and one or more kinds of olefin, and a resin obtained by copolymerizing propylene and one or more kinds of olefin with an unsaturated carboxylic acid and/or its derivative.

The unsaturated carboxylic acid used for the above-mentioned modification can be, for example, maleic acid, fumaric acid, itaconic acid, acrylic acid and methacrylic acid. The derivatives of the unsaturated carboxylic acids can be, for example, acid anhydrides, esters, amides, imides and metal salts of the acids. Specific examples thereof include maleic anhydride, itaconic anhydride, methyl acrylate, ethyl acrylate, butyl acrylate, glycidyl acrylate, methyl methacrylate, ethyl methacrylate, butyl methacrylate, glycidyl methacrylate, monoethyl maleate, diethyl maleate, monomethyl fumarate, dimethyl fumarate, acrylamide, methacrylamide, maleic acid monoamide, maleic acid diamide, furaric acid monoamide, maleimide, N-butylmaleimide and sodium methacrylate. Further, there can be used acids, such as citric acid and malic acid,.which forms unsaturated carboxylic acids by undergoing dehydration in the step of being grafted to polypropylene.

Preferred of these unsaturated carboxylic acids and the derivatives thereof are glycidyl esters of acrylic acid and methacrylic acid, and maleic anhydride. The modified polypropylene resins used in this invention are preferably those in which 0.1-10% by weight of the polymer-constituting units are formed by the above-mentioned unsaturated carboxylic acids or the derivatives thereof. Particularly, when these components are introduced into the polymer chain through random copolymerization or block copolymerization, the above-mentioned percentage is preferably 3-10% by weight, and when they are introduced through graft polymerization it is preferably 0.1-10% by weight. When the content of the unsaturated carboxylic acid or its derivative is too low, some mechanical strength, as impact strength and fatigue characteristic, may be low in some cases, whereas when it is too high, some mechanical strength, as rigidity, may be low in some cases.

The ratio of the weight of component (A) to the weight of component (B) (component (A)/component (B)) in this invention is 20/80-95/5, preferably 25/75-90/10, more preferably 30/70-80/20. When the proportion of the component (B) is too small, a sufficient reinforcing effect on such mechanical strength as rigidity and impact strength cannot be obtained, whereas when the proportion of the component (B) is too large, production and molding of glass fiber reinforced polypropylene resin tend to be difficult.

The intrinsic viscosity of the component (A) in this invention, in tetralin at 135° C., is not less than 1.15 dl/g and not more than 1.50 dl/g, preferably from 1.20 dl/g to 1.40 dl/g. When it is less than 1.15 dl/g, such mechanical strength as impact strength and fatigue characteristic tends to be low, whereas when it is more than 1.50 dl/g, molding of the resulting glass fiber reinforced polypropylene resin tends to be difficult.

The ratio of the weight of component (C) to the total weight of component (A) and component (B) (component (C)/[component (A)+component (B)]) in this invention is 0.30/100-5/100, preferably 0.30/100-2/100, more preferably 0.30/100-1/100. when the amount of the component (C) is too small, the durability of the resulting glass fiber reinforced polypropylene resin composition under circumstances of contact with metal tends to be low, whereas when the amount of the component (C) is too large such troubles as die contamination tend to occur at the time of molding.

The ratio of the weight of component (D) to the total weight of component (A) and component (B) (component (D)/[component (A)+component (B)]) in this invention is 0.15/100-5/100, preferably 0.15/100-2/100, more preferably 0.15/100-1/100. When the amount of the component (D) is too small, the durability of the resulting glass fiber reinforced polypropylene resin under circumstances of contact with metal tends to be low, whereas when the amount of the component (D) is too large, such troubles as die contamination tend to occur at the time of molding.

The amounts of the components (E)-(H) in this invention must be in such ranges that the ratio of the weight of component (E) to the weight of component (D) (component (E)/component (D)) is 1/1-3/1, preferably 1/1-2/1; the ratio of the weight of component (F) to the weight of component (D) (component (F)/component (D)) is not less than 1/10 and not more than 1/2, preferably 1/6-1/3; the ratio of the weight of component (G) to the weight of component (D) (component (G)/component (D)) is not less than 1/10 and not more than 1/2, preferably 1/6-1/3; and the ratio of the weight of component (H) to the weight of component (D) (component (H)/component (D)) is not less than 1/10 and not more than 1/2, preferably 1/6-1/3. When any of the ratios is outside the above-mentioned range, the durability of the resulting glass fiber reinforced polypropylene resin composition under conditions of contact with metal tends to be low, and such troubles as die contamination tend to occur at the time of molding.

The resin pellet in this invention may be incorporated, within ranges not much harmful to the object and effect of this invention, with one or more kinds of other polypropylene resin, nucleating agents and crystallization accelerators. Besides, in order to attain desired characteristic properties according to intended purposes, it may be further incorporated with known substances conventionally added to polypropylene resin, for example, neutralizers, antifoaming agents, flame retardants, flame retardant auxiliaries, dispersants, antistatic agents, lubricants, silica, coloring agents, such as dyes and pigments, and plasticizers. A length of the resin pellet is from 2 mm to 50 mm, preferably from 5 mm to 15 mm. A diameter of the resin pellet is preferably from 2 mm to 4 mm.

In producing such resin pellet, the method of pultrusion molding can be used in this invention. The method of pultrusion molding basically comprises impregnating continuous fiber strands with resin while pulling the fiber strands. Known methods of pultrusion molding include, for example, one which comprises impregnating fiber strands with resin by passing the strands through an impregnation liquid containing emulsion, suspension or solution of the resin, one which comprises blowing resin powder against fiber strands or passing fiber strands through a vessel containing resin powder, thereby to attach the resin to the fiber, and then melting the resin to impregnate the fiber strands with resin, and one which comprises, while passing fiber strands through a cross head, feeding resin from an extruder or the like to the cross head thereby to effect impregnation. Any of the known methods as described above may be used in this invention. Particularly preferred is a method which uses a cross head exemplified in JP-A-3-272830 and other literature. The operation of impregnation with resin in such pultrusion molding is commonly done in one step, but it may be performed in two or more separate steps.

The vehicle front structure of this invention is a part which is built-in at the front of a vehicle. It generally is provided with a shroud, which is a part for housing a radiator fan, or a shroud holddown member. It is, for example, a front and panel, bulk head or front end carrier. The front structure of this invention is preferably any one of the parts mentioned above.

In this invention, though the vehicle front structure can be formed by conventional known method of molding, it is preferable to conduct melt-blending in the molding by using a screw specially designed for glass fiber reinforced resins, whereby a vehicle front structure which can retain a high degree of mechanical strength can be obtained.

### EXAMPLES

This invention is described in detail below with reference to Examples, which are merely for the sake of illustration and in no way limit the invention.

The methods used for preparing samples for evaluation in Referential Examples and Examples are described below.

(1) Method for Preparation of Glass Fiber Pellet

The pellet was prepared by the method described in JP-A-3-121146. The impregnation temperature was 330° C., the take-off speed was 6 m/min and the fiber diameter of the glass fiber used was 16 μm.

(2) Injection Molding Conditions for Samples for Evaluation

The glass fiber pellet obtained was injection molded under the following conditions.

Samples for evaluation were injection molded by using the following molding machine mfd. by Nihon Seikosho Ltd.

Mold clamping force: 150 t

screw: glass fiber deep groove screw

screw diameter: 46 mm

screw L/D: 20.3

Samples for evaluation were molded under the following conditions to obtain test specimens (3.2 mm thick) of ASTM D638 TYPE 1.

cylinder temperature: 250° C.

mold temperature: 50° C.

back pressure: 0 MPa

The methods of evaluation used in Referential Examples and Examples are described below.

(1) Intrinsic Viscosity [η]

To 1.0 g of the pellet obtained above was added 100 ml of xylene and heated under reflux at 135° C. to extract polypropylene resin into xylene. The xylene solution of extracted polypropylene resin was dropwise added to 1,000 ml of methanol with stirring, to reprecipitate and recover polypropylene resin. The viscosity of the recovered sample was measured in tetralien at 135° C. by using an Ubbelohde's viscometer.

(2) Strength Retention Under Conditions of Contact with Copper Plate

The molded specimen prepared by the above-mentioned method was interposed between two copper plates and placed in a Geer oven at 160° C. to evaluate strength retention under conditions of contact with copper plates. Thus, respectively 250 hrs and 500 hrs after placing the molded specimens in the Geer oven, the respective molded specimens were taken out, and the tensile strength of the taken out specimens were determined according to A.S.T.M. D638 under the following conditions. Simultaneously, the tensile strength of a specimen which had not been placed in the Geer oven was determined, which was taken as the tensile strength of the specimen after 0 hr.

determination temperature: 23° C.

specimen thickness: 3.2 mm

stretching rate: 10 mm/min

Strength retention was calculated by the following equations. The figure in [ ] represents a period of time for which the specimen was placed in the Geer oven.

strength retention [250 hrs]=100×[(tensile strength [250 hrs])/(tensile strength [0 hr])]

strength retention [500 hrs]=100×[(tensile strength [500 hrs])/(tensile strength [0 hr])]

### Example 1

According to the method described in JP-A-3-121146, with the compounding composition shown in Table 1, pellets were prepared which have a glass fiber content of 40% by weight and pellet length of 9 mm. The result of intrinsic viscosity [η] determination of the component (A) present in the pellet obtained is shown in Table 1. The polypropylene resin (A-1) used comprises polypropylene resin (J-1) and modified polypropylene resin (K-1) in a weight ratio of resin (J-1) to resin (K-1) of 90:10. The polypropylene resin (J-1) used is a propylene homopolymer (MFR=25), and the modified polypropylene resin (K-1) is a maleic acid-modified polypropylene resin (MFR=40, maleic acid graft amount=0.2 wt%). The additives and their amounts compounded relative to 100 parts by weight of [component (A)+component (B)] are shown in Table 1.

The MFR was determined according to JIS K 7210 at a temperature of 230° C. and a load of 21.18N.

The pellets thus obtained were injection molded to obtain test specimens, and the strength retention of the specimens determined under conditions of contact with copper plates are shown in Table 1.

### Comparative Example 1

Preparation and comparison of test specimens were conducted in the same manner as in Example 1 except for changing the amounts of additives added as shown in Table 1. The results thus obtained are shown in Table 1.

TABLE 1

| | |
|---|---|
| | Comparative |
| Example 1 | Example 1 |

Composition (part by weight)

| | | | |
|---|---|---|---|
| (A) | Polypropylene resin | | |
| | Resin species | A-1 | A-1 |
| | Amount | 60 | 60 |
| (B) | Fiber | | |
| | Fiber species | B-1 | B-1 |
| | Amount | 40 | 40 |
| (C) | Metal deactivator | | |
| | Compound | C-1 | C-1 |
| | Amount | 0.45 | 0.21 |
| (D) | Phenol-based antioxidant | | |
| | Compound | D-1 | D-1 |
| | Amount | 0.20 | 0.11 |
| (E) | Sulfur-containing antioxidant | | |
| | Compound | E-1 | E-1 |
| | Amount | 0.50 | 0.23 |
| (F) | Hindered amine-based light stabilizer | | |
| | Compound | F-1 | F-1 |
| | Amount | 0.05 | — |
| (G) | Phosphorus-containing antioxidant | | |
| | Compound | G-1 | G-1 |
| | Amount | 0.10 | 0.05 |
| (H) | Ultraviolet absorber | | |
| | Compound | H-1 | H-1 |
| | Amount | 0.05 | 0.04 |
| (I) | Additive | | |
| | Compound | I-1 | I-1 |
| | Amount | 0.05 | 0.05 |
| | Compound | I-2 | I-2 |
| | Amount | 0.03 | 0.03 |

| | | |
|---|---|---|
| Results of evaluation | | |
| Intrinsic viscosity [η] (dl/g) | 1.21 | 1.10 |
| Strength retention [250 hrs] (%) | 93 | 45 |
| Strength retention [500 hrs] (%) | 94 | 21 |

Note:
A-1: polypropylene resin (G-1)/modified polypropylene resin (H-1) = 90/10
B-1: glass fiber (fiber diameter 16 μm)
C-1: Adekastab CDA-1M, mdf. by Asahi Denka Co., Ltd. [chemical name of main component: 3-(N-solicyloyl)amino-1,2,4-triazole]
D-1: Sumilizer GA80, mdf. by Sumitomo Chemical Co., Ltd. [chemical name: 3,9-bis[1,1-dimethyl-2-(β-(3-t-butyl-4-hydroxy-5-methylphenyl)propionyloxy)ethyl]-2,4,8,10-tetraoxaspiro[5.5]undecane]
E-1: Sumilizer TPM, mfd. by Sumitomo chemical Co., Ltd. [chemical name: dimyristyl thiodipropionate]
F-1: HA70G, mfd. by Sankyo Co., Ltd. [chemical name: bis(2,2,6,6-tetramethyl-4-piperidyl)sebacate]
G-1: Ultranox 626, mfd. by GE Specialty Chemicals Co. [chemical name: bis(2,4-di-t-butylphenyl)-pentaerythritol diphosphite]
H-1: Biosorb 80, mfd. by Kyodo Chemical Co., Ltd. [chemical name: 2,4-di-t-bytylphenyl 3′,5′-di-t-butyl-4′-hydroxybenzoate]
I-1: Electrostripper TS-5, mfd. by Kao Corp. [chemical name: glycerol monostearate]
I-2: calcium stearate
J-1: propylene homopolymer (MFR = 25)
K-1: maleic acid-modified polypropylene resin (MFR = 40, maleic acid graft amount = 0.2 wt %)

### EFFECTS OF THE INVENTION

As set forth above, according to this invention, there can be provided glass fiber reinforced polypropylene resin pellet excellent in durability in long term use under circumstances of contact with metal and vehicle front structures obtained from the resin pellet.

What is claimed is:

1. A glass fiber reinforced polypropylene resin pellet comprising the following components (A)-(H), the ratio of the weight of the component (A) to the weight of the component (B) (component (A)/component (B)) being 20/80-95/5, the ratio of the weight of the component (C) to the total weight of the component (A) and the component (B) (component (C)/[component (A)+component (B)]) being 0.30/100-5/100, the ratio of the weight of the component (D) to the total weight of the component (A) and the component (B) (component (D)/[component (A)+component (B)]) being 0.15/100-5/100, the ratio of the weight of the component (E) to the weight of the component (D) (component (E)/component (D)) being 1/1-3/1, the ratio of the weight of the component (F) to the weight of the component (D) (component (F)/component (D)) being not less than 1/10 and not more than 1/2, the ratio of the weight of the component (G) to the weight of the component (D) (component (G)/component (D)) being not less than 1/10 and not more than 1/2, the ratio of the weight of the component (H) to the weight of the component (D) (component (H)/component (D)) being not less than 1/10 and not more than 1/2, wherein the component (B) is arranged in parallel to one another with a length approximately equal to a pellet length, the pellet length is 2-50 mm, and an intrinsic viscosity of the component (A) in tetralin at 135° C. is not less than 1.15 g/dl and not more than 1.50 g/dl,
(A): polypropylene resin,
(B): glass fiber,
(C): heavy metal deactivator,
(D): phenol-based antioxidant
(E): sulfur-containing antioxidant
(F): hindered amine-based light stabilizer,
(G): phosphorus-containing antioxidant,
(H): ultraviolet absorber.

2. The glass fiber reinforced polypropylene resin pellet according to claim 1 wherein the polypropylene resin is a modified polypropylene resin in which a part or the whole part of the polypropylene is modified with an unsaturated carboxylic acid or a derivative thereof.

3. A vehicle front structure obtained by melt-kneading the fiber reinforced resin pellet according to claims 1 or 2, feeding the resulting molten pellet to a mold comprising a pair of male and female dies, and then solidifying it.

4. A process for producing a vehicle front structure comprising the steps of melt-kneading the fiber reinforced resin pellet according to claims 1 or 2, feeding the resulting molten pellet to a mold comprising a pair of male and female dies, and then solidifying it.
